(19) United States
(12) Patent Application Publication
(10) Pub. No.: US 2020/0250379 A1
(43) Pub. Date: Aug. 6, 2020

(54) METHOD AND APPARATUS FOR TEXTUAL SEMANTIC ENCODING

(71) Applicant: Alibaba Group Holding Limited, Grand Cayman (KY)

(72) Inventor: Chenglong WANG, Hangzhou (CN)

(21) Appl. No.: 16/754,832

(22) PCT Filed: Oct. 24, 2018
(86) PCT No.: PCT/CN2018/111628

§ 371 Date: Apr. 9, 2020

(30) Foreign Application Priority Data
Oct. 27, 2017 (CN) 201711056845.2

(51) Int. Cl. G06F 40/30; G06N 3/04; G06N 3/08

(52) U.S. Cl. CPC G06F 40/30; G06N 3/084; G06N 3/049

(57) ABSTRACT

Embodiments of the disclosure provide a method and an apparatus for textual semantic encoding. In one embodiment, the method comprises: generating a matrix of word vectors based on textual data; inputting the matrix of word vectors into a bidirectional recurrent neural network to pre-processing the matrix of word vectors into output vectors, the output vectors representing contextual semantic relationships; performing convolution on the output vectors to obtain a convolution result, the convolution result representing to a topic; and performing pooling on the convolution result to obtain a fixed-length vector as a semantic encoding of the textual data, the semantic encoding representing the topic of the textual data.

### CROSS-REFERENCE TO RELATED APPLICATIONS

The disclosure is a national stage entry of Int'l Appl. No. PCT/CN2018/111628, filed on Oct. 24, 2018, which claims priority to Chinese Patent Application No. 201711056845.2, filed on Oct. 27, 2017, both of which are incorporated herein by reference in their entirety.

### BACKGROUND

### Technical Field

The disclosure relates to the field of computer technology and, in particular, to methods and apparatuses for textual semantic encoding.

### Description of the Related Art

Many applications require a Questions and Answers (QA) service to be provided to users. For instance, Internet-based applications frequently provide customer services regarding the features thereof to help users to better understand topics such as product features, service functionalities, and the like. In the process of QA, the communication between a user and a customer service agent is usually conducted in the form of natural language texts. As the number of applications or users serviced by the applications increases, pressure on customer service increases as well. As a result, many service providers resort to technologies such as text mining or information indexing to provide users with automatic QA services, replacing the costly, poorly-scalable investment into manual QA services.

To mine and process natural language-based textual data associated with questions and answers, numeric encoding (e.g., text encoding) is performed on textual data. Presently, systems use a bag-of-words technique to encode texts of varying lengths. Each item of textual data is processed using a vector of integral numbers of a length V, the length (V) indicating the size of a dictionary, each element of the vector representing one word, the value of which represents a number of occurrences of the word in the textual data. However, this encoding technique uses only the frequency information associated with the words in the textual data, thus ignoring the contextual dependency relationships between the words. As such, it is difficult to represent the semantical information of the textual data fully. Further, with the bag-of-words technique, an encoding length is the size of the entire dictionary (e.g., typically in an order of hundreds of thousand words), the vast majority of which have an encoded value of zero (0). Such encoding sparsity is disadvantageous to subsequent text mining, and the excessively lengthy encoding length reduces the speed of subsequent text processing.

To address the problems with bag-of-words encoding, techniques of word embedding are developed to encode textual data. Such techniques use fixed-length vectors of real numbers to represent the semantics of textual data. The word embedding encoding techniques are a type of dimensionality-reduction based data representation. Specifically, the semantics of textual data are represented using a fixed-length (typically in 100 dimensions) vector of real numbers. Compared with bag-of-words encoding, the word dimensions reduces the dimensionality of the data, solving the data sparsity problem, and improving the speed of subsequent text processing. However, the word embedding techniques generally require pre-training. That is, during offline training, where textual data for encoding has to be determined. As such, the algorithm is generally used to encode and represent short-length texts (e.g., words or phrases) with enumerated dimensions. However, textual data captured at the sentence or paragraph levels includes sequences of data having varying-lengths, the dimensions of which cannot be enumerated. As a result, such text-based data is not suitable for being encoded with the afore-described pre-trainings.

Therefore, there exists a need for accurately encoding textual data of varying lengths.

### SUMMARY

The disclosure provides methods, computer-readable media, and apparatuses for textual semantic encoding to solve the above-described technical problems of the prior art failing to encode textual data of varying lengths accurately.

In one embodiment, the disclosure provides a method for textual semantic encoding, the method comprising: generating a matrix of word vectors based on textual data; inputting the matrix of word vectors into a bidirectional recurrent neural network to pre-process the matrix of word vectors into output vectors, the output vectors representing contextual semantic relationships; performing convolution on the output vectors to obtain a convolution result, the convolution result being related to a topic; and performing pooling on the convolution result to obtain a fixed-length vector as a semantic encoding of the textual data, the semantic encoding representing the topic of the textual data.

In one embodiment, the disclosure provides an apparatus for textual semantic encoding, the apparatus comprising: a matrix of word vectors generating unit configured to generate a matrix of word vectors based on textual data; a pre-processing unit configured to input the matrix of word vectors into a bidirectional recurrent neural network to pre-process the matrix of word vectors into output vectors, the output vectors representing contextual semantic relationships; a convolution processing unit configured to perform convolution on the output vectors to obtain a convolution result, the convolution result being related to a topic; and a pooling processing unit configured to perform pooling on the convolution result to obtain a fixed-length vector as a semantic encoding of the textual data, the semantic encoding representing the topic of the textual data.

In one embodiment, the disclosure provides an apparatus for textual semantic encoding, the apparatus comprising a memory storing a plurality of programs, when read and executed by one or more processors, instructing the apparatus to perform the following operations of generating a matrix of word vectors based on textual data; inputting the matrix of word vectors into a bidirectional recurrent neural network to pre-process the matrix of word vectors into output vectors, the output vectors representing contextual semantic relationships; performing convolution on the output vectors to obtain a convolution result, the convolution result being related to a topic; and performing pooling on the convolution result to obtain a fixed-length vector as a semantic encoding of the textual data, the semantic encoding representing the topic of the textual data.

In one embodiment, the disclosure provides a computer-readable medium having instructions stored thereon, wherein the instructions, when executed by one or more processors, instructing an apparatus to perform the textual semantic encoding methods according to embodiments of the disclosure.

In various embodiments of the disclosure, varying-length textual data from different data sources is processed to generate a matrix of word vectors, which are in turn inputted into a bidirectional recurrent neural network for pre-processing. Subsequently, linear convolution and pooling are performed on the output of the recurrent neural network to obtain a fixed-length vector of real numbers as a semantic encoding for the varying-length textual data. Such semantic encoding can be used in any subsequent text mining tasks. Further, the disclosure provides mechanisms to mine semantical relationships of textual data, as well as correlations between textual data and its respective topics, achieving fixed-length semantic encoding of varying-length textual data.

### BRIEF DESCRIPTION OF THE DRAWINGS

The drawings to be used for the description of embodiments are briefly introduced below. The drawings in the following description are some embodiments of the disclosure. Those of ordinary skill in the art can further obtain other drawings according to these accompanying drawings without significant efforts.

FIG. 1 is a diagram illustrating an application scenario according to some embodiments of the disclosure.

FIG. 2 is a flow diagram illustrating a method for textual semantic encoding according to some embodiments of the disclosure.

FIG. 3 is a diagram illustrating a method for textual semantic encoding according to some embodiments of the disclosure.

FIG. 4 is a block diagram illustrating an apparatus for textual semantic encoding according to some embodiments of the disclosure.

FIG. 5 is a block diagram illustrating an apparatus for textual semantic encoding according to some embodiments of the disclosure.

FIG. 6 is a flow diagram illustrating a method for textual semantic encoding according to some embodiments of the disclosure.

FIG. 7 is a block diagram of an apparatus for textual semantic encoding according to some embodiments of the disclosure.

### DETAILED DESCRIPTION

In some embodiments of the disclosure, methods, computer-readable media, and apparatuses are provided for textual semantic encoding to achieve textual semantic encoding of varying-length textual data.

The terms used in the embodiments of the disclosure are intended solely for the purpose of describing particular embodiments rather than limiting the disclosure. As used in the embodiments of the disclosure and in the claims, the singular forms “an,” “said” and “the” are also intended to include the case of plural forms, unless the context clearly indicates otherwise. The term “and/or” used herein refers to and includes any or all possible combinations of one or a plurality of associated listed items.

As used herein, the term “textual encoding” refers to a vectorized representation of a varying-length natural language text. In some embodiments of the disclosure, a varying-length natural language text may be represented as a fixed-length vector of real numbers via textual encoding.

The above definition of the terms is set forth solely for understanding the disclosure without imposing any limitation.

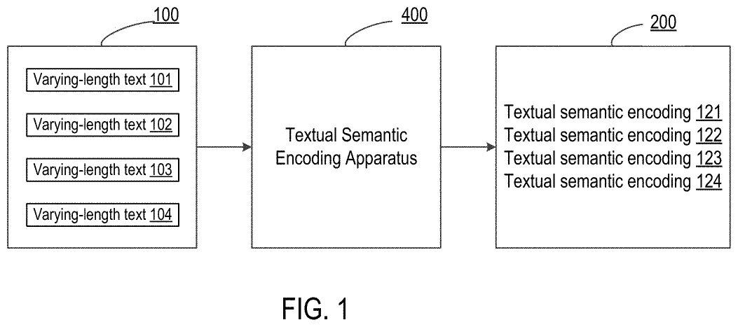

FIG. 1 illustrates an exemplary application scenario according to some embodiments of the disclosure. In this example, an encoding method according to an embodiment of the disclosure is applied to a scenario as shown in FIG. 1 to perform textual semantic encoding. The illustrated method can also be applied to any other scenarios without limitation. As shown herein FIG. 1, in an exemplary application scenario, an electronic device (100) is configured to obtain textual data. In this example, the textual data includes a varying-length text (101), a varying-length text (102), a varying-length text (103), and a varying-length text (104), each having a length that may be different. After being obtained, the textual data is input into a textual semantic encoding apparatus (400). In the illustrated embodiment, the textual semantic encoding apparatus (400) performs the operations of word segmentation, a matrix of word vectors generation, bidirectional recurrent neural network pre-processing, convolution, and pooling to generate a fixed-length semantic encoding. As an output, the textual semantic encoding apparatus (400) produces a set of corresponding semantic encodings. As shown herein, the set of semantic encodings (200) includes a textual semantic encoding (121), a textual semantic encoding (122), a textual semantic encoding (123), and a textual semantic encoding (124), each of which has the same length. This way, varying-length textual data is transformed into a textual semantic encoding of a fixed-length. Further, a topic reflected by a text is represented by the respective textual semantic encoding, providing a basis for subsequent data mining.

The above-described application scenario is illustrated for understanding the disclosure only, and is presented without limitation. Embodiments of the disclosure can be applied to any suitable scenarios.

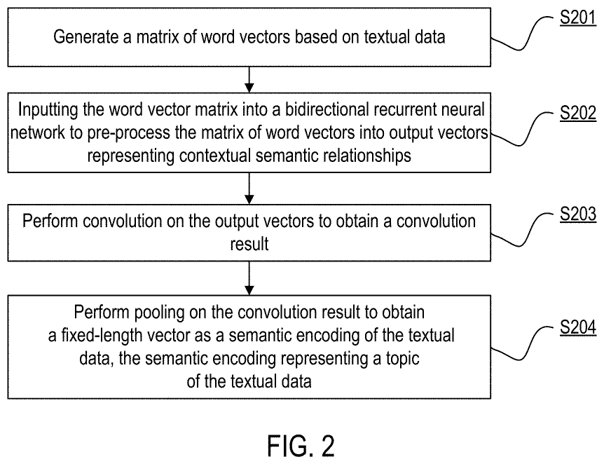

The following illustrates a method for textual semantic encoding according to some exemplary embodiments of the disclosure with reference to FIGS. 2, 3, and 6.

FIG. 2 is a flow diagram illustrating a method for textual semantic encoding according to some embodiments of the disclosure. As shown in FIG. 2, the method of textual semantic encoding includes the following steps.

Step S201: generate a matrix of word vectors based on textual data.

In some embodiments, step S201 further includes the following sub-steps.

Sub-step S201A: obtain the textual data. In some embodiments, texts from various data sources are obtained as the textual data. Taking a QA system as an example, a question from a user can be used as the textual data. For instance, a question input by the user (e.g., “How to use this function?”) can be collected as the textual data. In another example, an answer from a customer service agent of a QA system can also be collected as the textual data. For instance, a text-based answer from the customer service agent (e.g., “The operation steps of the product-sharing function are as follows: log in to a Taobao account; open a page featuring the product; click the ‘share’ button; select an Alipay friend; and click the ‘send’ button to complete the product sharing function”) can be collected as the textual data. Any other text-based data can be obtained as the textual data without limitation.

Again, the textual data is of varying-length. In other words, each item of the textual data is not limited to a fixed length, as in any natural language-based text.

Sub-step S201B: perform word segmentation on the textual data to obtain a word sequence.

In some embodiments, the word sequence obtained via segmentations on the input text is represented as:

[w₁, . . . ,wᵢ. . . w_{|s|}]

where wᵢ is the i^{th} word following the segmentation of the input text, and |s| is the length of the text post segmentations. For example, for an item of textual data of “How to use this function,” after segmentations, the item of textual data is represented as a word sequence of [How, to, use, this, function]. The word sequence has a length of five (5), corresponding to the number of words in the word sequence. As illustrated in this example, individual English words are delineated with spaces in the text. In other languages such as Chinese, word boundaries can be implicit rather than explicit in an item of textual data. Absent spaces and punctuation marks, a group of Chinese characters (also words by themselves), can constitute one word in the context of a sentence. For the purpose of simplicity, word segmentation is illustrated with the above-described English text example. For the purpose of clarity, the Chinese text corresponding to the above-described example and the respective word segmentation in Chinese (delineated with coma) are also illustrated below in Table 1.

TABLE 1

| | |
|---|---|
| Text in Chinese: | [symbol] ? |
| Word Segmentation in Chinese: | [symbol] |

Sub-step S201C: determine a word vector corresponding to each word in the word sequence and generating a matrix of the word vectors.

In some embodiments, the above-described word sequence is encoded using the word embedding technique to generate a matrix of word vectors:

[v₁, . . . ,vᵢ. . . v_{|s|}]

The word vector corresponding to the ith word is computed according to:

vᵢ=LT_{W}(wᵢ) (1)

where W∈R^{d×|v|} is a pre-trained word vector (e.g., vectors generated using word embedding) matrix, |v| is the number of words in the matrix of word vectors, d is the encoding length of the word vector (e.g., vectors generated using word embedding), R is the real number space, and LT is the lookup table function. Each column of the matrix represents a word embedding based encoding corresponding to each of the word in the word sequence. This way, any textual data can be represented as a matrix S of d×|s|, S representing a matrix of word vectors corresponding to words in the input textual data.

Word embedding is a natural language processing encoding technique, which is used to generate a word vector matrix of a size of |v|*d. For example, each column of the matrix represents one word, such as the word of “how”, and the respective vector column represents an encoding for the word of “how”. Here, |v| represents the number of words in a dictionary and d represents the length of an encoding vector. For one sentence such as the above-described example of “how to use this function,” the sentence is first segmented into words (e.g., a word sequence) of “how”, “to”, “use”, “this”, and “function.” Next, an encoding vector corresponding to each word is searched for. For instance, the vector corresponding to the word “this” can be identified as [−0.01, 0.03, 0.02, . . . , 0.06]. These five words each are represented in their respective vector expressions. The five vectors together form the matrix representing the sentence of the example textual data

Step 202: input the matrix of word vectors into a bidirectional recurrent neural network to pre-process the matrix of word vectors into output vectors representing contextual semantic relationships.

In some embodiments, step 202 includes: inputting the matrix of word vectors into the bidirectional recurrent neural network; performing computations, via a long short-term memory (LSTM) unit (e.g., neural network unit) to perform forward processing to obtain semantic dependency relationship between each word and its preceding context text(s), and to perform backward processing to obtain semantic dependency relationship between each word vector and its following context text(s); and using the semantic dependency relationships between each of the word vectors and their respective preceding context text(s) and the following context text(s) as the output vectors.

In one implementation, the word vector matrix S generated at step S202 is pre-processed using a bidirectional recurrent neural network, a computing unit of which utilizes a long-short term memory (LSTM) unit. The bidirectional recurrent neural network includes a forward process (with a processing order as w₁→w_{|S|}), and a backward process (with a processing order as w_{|S|}→w₁). For each input vector vᵢ, the forward process generates an output vector hᵢ^{f}∈R^{d}; and correspondingly, the backward process generates an output vector hᵢ^{b}∈R^{d}. These vectors represent each word wᵢ and the respective semantic information of their preceding context text(s) (corresponding to the forward process) or following context text(s) (corresponding to the backward process) thereof. Next, the output vectors are computed using the following formula:

hᵢ=[hᵢ^{f}; hᵢ^{b}] (2)

where hᵢ is the respective intermediary encoding of wᵢ; hᵢ^{f} is the vector generated by processing an inputted word i in the above-described forward process of the bidirectional recurrent neural network, representing the semantic dependency relationship between the word i and its preceding context text(s); and hᵢ^{b} is the vector generated by processing the inputted word i in the above-described backward process of the bidirectional recurrent neural network, representing the semantic dependency relationship between the word i and its following context text(s).

Step S203: perform convolution on the output vectors to obtain a convolution result, the convolution result being related to a topic.

In some embodiments, step S203 includes the following sub-steps.

Sub-step S203A: perform a linear convolution operation on the output vectors using a convolution kernel, the convolution kernel related to the topic.

In implementations, a convolution kernel F∈R^{d×m} (m representing the size of a convolution window) is utilized to perform a linear convolution operation on H∈R^{2d×|S|} to obtain a vector C∈R^{(|S|-m+1)}, where:

cᵢ=(H*F)ᵢ=Σ(H_{:,i:i+m-1}·F) (3)

where the convolution kernel F is related to the topic.

In some embodiments, sub-step S203A includes performing a convolution operation on the output vector H using a group of convolution kernels F via applying the following formula:

cⱼᵢ=E(H_{:,i:i+m-1}·Fⱼ)+bᵢ (4)

where cⱼᵢ is a vector as the result of the convolution operation, H is the output vector of the bidirectional recurrent neural network, Fⱼ is the j^{th} convolution kernel, bᵢ is a bias value corresponding to the convolution kernel Fⱼ, i is an integer, j is an integer, and m is the size of the convolution window.

In some embodiments, a group of convolution kernels F∈R^{(n×d×m)} are used to perform convolution operation(s) on H to obtain a matrix C∈R^{(n×(|S|-m+1)}), which represents a vector as the result of the convolution operation(s). Further, each convolution kernel Fⱼ corresponds to a respective bias value bᵢ.

In implementations, the size of a convolution kernel is also determined when the convolution kernel for use is determined. In one example, each convolution kernel includes a two-dimensional vector, the size of which is obtained via adjustments based on different application scenarios; and the value of the vector is obtained through supervised learning. In some embodiments, the convolution kernel is obtained via neural network training. In one example, vectors corresponding to the convolution kernels are obtained by performing supervised learning techniques on training samples.

Sub-step S203B: perform a nonlinear transformation on a result of the linear convolution operation to obtain the convolution result.

In some embodiments, to encode with nonlinear expression capabilities, one or more nonlinear activation functions (e.g., softmax, rectified linear unit (Relu)) are added to the convolutional layer. Taking Relu as an example, the output result is A E R^{(n×(|S|-m+1)}), where:

aᵢⱼ=max(0,cᵢⱼ) (5)

where A is the variable computed as a result of Relu processing. Here, aᵢⱼ is a variable associated with A. After the above-described processing, each aᵢⱼ is processed into a numerical value greater than or equal to 0.

Step S204: perform pooling on the convolution result to obtain a fixed-length vector as a semantic encoding of the textual data, the semantic encoding representing the topic of the textual data.

In some embodiments, max-pooling is performed on the convolution result to eliminate the varying lengths associated with the results. This way, a fixed-length vector of real numbers is obtained as the semantic encoding of the textual data. the value of each element of the vector indicates an extent to which the textual data reflects the topic.

In some embodiments, the matrix A obtained at step S203 is processed by max-pooling. In text encoding, pooling is used to eliminate the effect that vector lengths are of varying values. In implementations, for an input matrix A, each row of the matrix A corresponds to a vector of real numbers that is obtained by convolution using a corresponding convolution kernel. A value that is the greatest amongst these values of the vectors is computed as:

pᵢ=max(A_{i,:}) (6)

where the final result P E R″ is the final encoding of the target textual data.

In some embodiments, each element of the result vector P represents a “topic”, and the value of each element represents an extent to which the “topic” is reflected by the textual data.

In various embodiments, once the semantic encoding corresponding to the textual data is obtained, multiple kinds of processing can be performed based on the semantic encoding. For example, since the obtained textual semantic encoding is a vector of real numbers, subsequent processing can be performed using common operations upon vectors. In one example, a cosine distance of two respective encodings is computed to represent the similarity between two items of textual data. According to various embodiments of the disclosure, any subsequent processing of textual semantic encodings post to obtaining the above-described semantic encoding of the textual data can be performed without limitation.

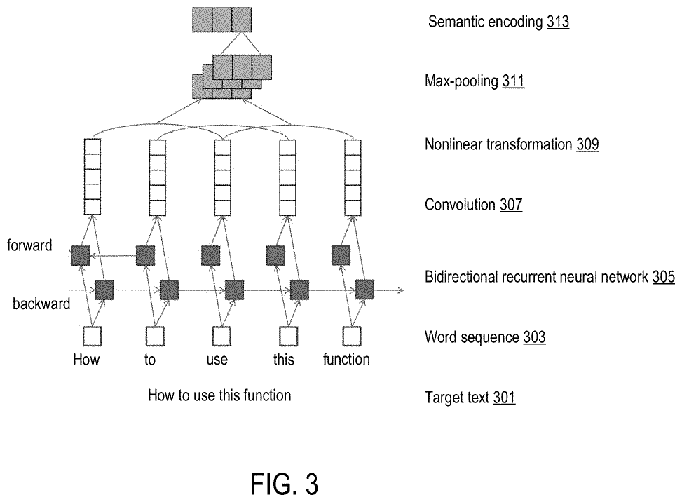

FIG. 3 is a diagram illustrating a method for textual semantic encoding according to some embodiments of the disclosure. As shown in FIG. 3, an item of textual data of “How to use this function” is the target textual data (301). The target textual data is parsed into a word sequence (303) of [How, to, use, this, function] upon word segmentation. Each segmented word is encoded using a word vector. A matrix of these word vectors is inputted into a bidirectional recurrent neural network (305) to be processed to obtain an output result. Upon the operations of linear convolution (307), nonlinear transformation (309), and max-pooling (311) on the output result, the effect that each word vector having a varying length is eliminated. As a result, a fixed-length vector is obtained as the semantic encoding (313) of the textual data. In various embodiments of the disclosure, textual data of varying lengths is processed to be initially represented as a matrix of word vectors, and then a fixed-length vector of real numbers is obtained using a bidirectional recurrent neural network and convolution-related operations. Such a fixed-length vector of real numbers is the semantic encoding of the textual data. This way, textual data of varying lengths are transformed into textual semantic encodings of a fixed-length; and the semantics relationships of the textual data as well as the topic expression of the textual data are mined.

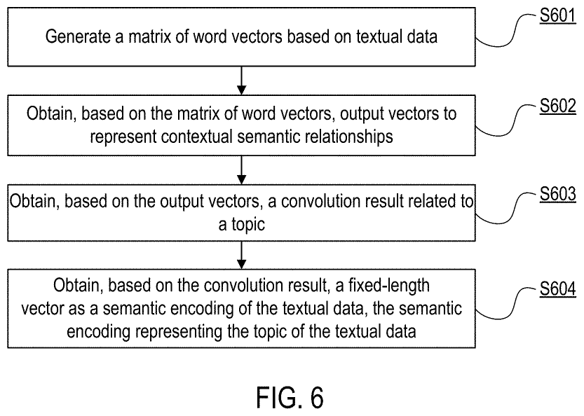

FIG. 6 illustrates a flow diagram illustrating a method for textual semantic encoding according to some embodiments of the disclosure. The method for textual semantic encoding includes the following steps.

Step S601: generate a matrix of word vectors based on textual data.

In some embodiments, step S601 includes the following sub-steps.

Sub-step S601A: obtain the textual data. In various embodiments, the textual data is of varying lengths. In some embodiments, the textual data is obtained in a manner substantially similar to sub-step S201A as above-described with reference to FIG. 2, the details of which are not repeated herein.

Step S601B: perform word segmentation on the textual data to obtain a word sequence. In some embodiments, the textual data is obtained in a manner substantially similar to sub-step S201B as above-described with reference to FIG. 2, the details of which are not repeated herein.

Step S601C: determine a word vector corresponding to each word in the word sequence and generating a matrix of the word vectors. In some embodiments, the word vector and the matrix of word vectors are obtained in a manner substantially similar to sub-step S201C as above-described with reference FIG. 2, the details of which are not repeated herein.

Step S602: obtain, based on the matrix of word vectors, output vectors to represent contextual semantic relationships.

In some embodiments, step S602 includes: pre-processing the matrix of word vectors by inputting the matrix of word vectors into a bidirectional recurrent neural network to obtain output vectors representing contextual semantic relationships. In implementations, the matrix of word vectors is inputted into the bidirectional recurrent neural network, and a Long Short-Term Memory (LSTM) unit is used for computation. In one example, forward processing is performed to obtain a semantic dependency relationship between each word vector and its preceding contextual text(s); and backward processing is performed to obtain a semantic dependency relationship between each word vector and its following contextual text(s). The semantic dependency relationships between each word vector and the respective preceding contextual text(s) and the respective following contextual text(s) form the output vectors. In various embodiments, any suitable techniques can be applied to generate the output vectors without limitation.

Step S603: obtain, based on the output vectors, a convolution result related to a topic.

In some embodiments, a linear convolution operation is performed on the output vectors using a convolution kernel, which is related to a topic. A nonlinear transformation is performed on a result of the linear convolution to obtain the convolution result.

Step S604: obtain, based on the convolution result, a fixed-length vector as the semantic encoding of the textual data, the semantic encoding representing the topic of the textual data.

In some embodiments, max-pooling is performed on the convolution result to eliminate the varying vector lengths associated with the result to obtain a fixed-length vector of real numbers. Such a fixed-length vector of real numbers is generated as the semantic encoding of the textual data, the value of each element of the vector representing an extent to which the text reflects the topic.

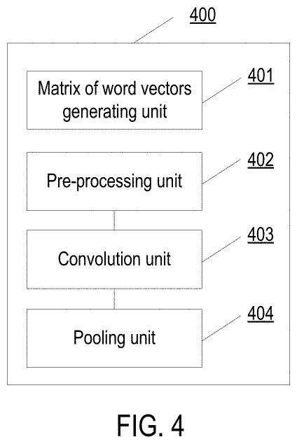

Now referring back to FIG. 4, a block diagram of an apparatus for textual semantic encoding is disclosed, according to some embodiments of the disclosure. As shown in FIG. 4, the apparatus (400) includes a matrix of word vectors generating unit (401), a pre-processing unit (402), a convolution unit (403), and a pooling unit (404).

The matrix of word vectors generating unit (401) is configured to generate a matrix of word vectors based on textual data. In some embodiments, the matrix of word vectors generating unit 401 is configured to implement step S201 as above-described with reference to FIG. 2, the details of which are not repeated herein.

The pre-processing unit (402) is configured to input the matrix of word vectors into a bidirectional recurrent neural network to pre-process the matrix of word vectors into an output vector, the output vectors representing contextual semantic relationships. In some embodiments, the pre-processing unit (402) is configured to implement step S202 as above-described with reference to FIG. 2, the details of which are not repeated herein.

The convolution unit (403) is configured to perform convolution on the output vectors to obtain a convolution result, the convolution result being related to a topic. In some embodiments, the convolution processing unit (403) is configured to implement step S203 as above-described with reference to FIG. 2, the details of which are not repeated herein.

The pooling unit (404) is configured to perform pooling on the convolution result to obtain a fixed-length vector as a semantic encoding of the textual data, the semantic encoding representing the topic of the textual data. In some embodiments, the pooling unit (404) is configured to implement step S204 as above-described with reference to FIG. 2, the details of which are not repeated herein.

In some embodiments, the matrix of word vectors generating unit (401) further includes an obtaining unit configured to obtain the textual data. In one embodiment, the obtaining unit is configured to implement sub-step S201A as above-described with reference to FIG. 2, the details of which are not repeated herein.

In some embodiments, the matrix of word vectors generating unit (401) further includes a word segmentation unit configured to perform word segmentation on the textual data to obtain a word sequence. In some embodiments, the word segmentation unit is configured to implement sub-step S201B as above-described with reference to FIG. 2, the details of which are not repeated herein.

In some embodiments, the matrix of word vectors generating unit (401) further includes a matrix generating unit configured to determine a word vector (e.g., vector obtained based on word embedding) corresponding to each word in the word sequence and to generate the matrix of these word vectors. In some embodiments, the matrix generating unit is configured to implement step S201C as above-described with reference to FIG. 2, the details of which are not repeated herein.

In some embodiments, the pre-processing unit (402) is further configured to input the matrix of word vectors into the bidirectional recurrent neural network and to perform computations using a Long Short-Term Memory (LSTM) unit. In some examples, forward processing is performed to obtain a semantic dependency relationship between each word vector and its preceding contextual text(s); and backward processing is performed to obtain a semantic dependency relationship between each word vector and its following contextual text(s). The semantic dependency relationships between each word vector and the respective preceding contextual text(s) and the respective following contextual text(s) are computed as the output vectors.

In some embodiments, the convolution processing unit (403) further includes a convolution unit and a nonlinear transformation unit. The convolution unit is configured to perform a linear convolution on the output vectors using a convolution kernel, which is related to a topic.

The nonlinear transformation unit is configured to perform a nonlinear transformation on the result of the linear convolution to obtain the convolution result.

In some embodiments, the convolution unit is configured to perform the convolution operation on the output vectors via a group of convolution kernels F using the following formula:

cⱼᵢ=Σ(H_{:,i:i+m-1}·Fⱼ)−bᵢ (7)

where cⱼᵢ is a vector as a result of the convolution operation; H is the output vector of the bidirectional recurrent neural network; Fⱼ is the j^{th} convolution kernel; bᵢ is a bias value corresponding to the convolution kernel Fⱼ; i is an integer; j is an integer; and m is the size of the convolution window.

In some embodiments, the pooling unit (404) is configured to perform max-pooling on the convolution result to eliminate the varying lengths associated with the result to obtain a fixed-length vector of real numbers as the semantic encoding of the textual data. The value of each element of the vector represents an extent to which the text reflects the topic.

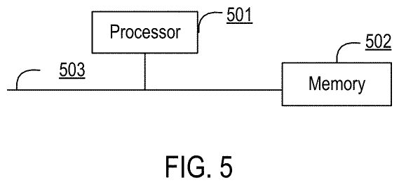

FIG. 5 is a block diagram illustrating an apparatus for textual semantic encoding, according to some embodiments of the disclosure. As shown in FIG. 5, the textual semantic encoding apparatus includes one or more processors (501) (e.g., CPU), a memory (502), and a communication bus (503) for communicatively connecting the one or more processors (501) and the memory (502). The one or more processors (501) are configured to execute an executable module such as a computer program stored in the memory (502).

The memory (502) may be configured to include a high-speed Random Access Memory (RAM), a non-volatile memory (e.g., a disc memory), and the like. The memory (502) stores one or more programs including instructions, when executed by the one or more processors (501), instructing the apparatus to perform the following operations: generating a matrix of word vectors based on textual data; inputting the matrix of word vectors into a bidirectional recurrent neural network to pre-process the matrix of word vectors into output vectors, the output vectors representing contextual semantic relationships; performing convolution on the output vectors to obtain a convolution result, the convolution result being related to a topic; and performing pooling on the convolution result to obtain a fixed-length vector as a semantic encoding of the textual data, the semantic encoding representing the topic of the textual data.

In some embodiments, the one or more processors (501) are configured to execute the one or more programs including instructions for inputting the matrix of word vectors into the bidirectional recurrent neural network; performing computations using a Long Short-Term Memory (LSTM) unit; performing forward processing to obtain semantic dependency relationship between each word vector and its preceding contextual text(s); performing backward processing to obtain semantic dependency relationship between each word vector and its following contextual text(s); and using the semantic dependency relationships between each word vector and the respective preceding contextual text(s) and the respective following contextual text(s) to generate the output vectors.

In some embodiments, the one or more processors (501) are configured to execute the one or more programs including instructions for performing a linear convolution operation on the output vectors using a convolution kernel, the convolution kernel being related to a topic; and performing a nonlinear transformation on the result of the linear convolution operation to obtain the convolution result.

In some embodiments, the one or more processors (501) are configured to execute the one or more programs including instructions for performing max-pooling on the convolution result to eliminate the varying lengths associated with the result to obtain a fixed-length vector of real numbers as the semantic encoding of the textual data, the value of each element of the vector representing an extent to which the text reflects the topic.

In some embodiments, the disclosure further provides a non-transitory computer-readable storage medium storing instructions thereon. For example, a memory may store instructions, when executed by a processor, instructing an apparatus to perform the methods as above-described with references to FIGS. 1-3 and 6. In some embodiments, the non-transitory computer-readable storage medium may be a Random Access Memory (ROM), a Random Access Memory (RAM), a CD-ROM, a tape, a floppy disk, an optical data storage device, etc.

In some embodiments, the disclosure further provides a computer-readable medium. In one example, the computer-readable medium is a non-transitory computer-readable storage medium storing thereon instructions, when executed by a processor of an apparatus (e.g., a client device or server), instructing the apparatus to perform a method of textual semantic encoding, the method including generating a matrix of word vectors based on textual data; inputting the matrix of word vectors into a bidirectional recurrent neural network to pre-process the matrix of word vectors into output vectors, the output vectors representing contextual semantic relationships; performing convolution on the output vectors to obtain a convolution result, the convolution result being related to a topic; and performing pooling on the convolution result to obtain a fixed-length vector as a semantic encoding of the textual data, the semantic encoding representing the topic of the textual data.

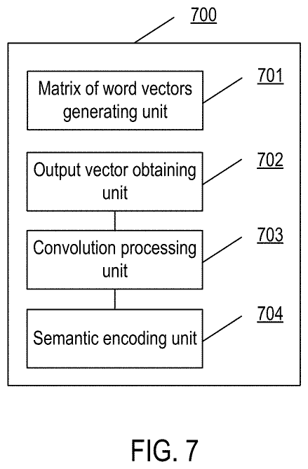

FIG. 7 is a block diagram illustrating an apparatus of textual semantic encoding, according to some embodiments of the disclosure. As shown herein FIG. 7, the textual semantic encoding apparatus (700) includes a matrix of word vectors generating unit (701), an output vector obtaining unit (702), a convolution processing unit (703), and a semantic encoding unit (704).

The matrix of word vectors generating unit (701) is configured to generate a matrix of word vectors based on textual data. In some embodiments, the matrix of word vectors generating unit (701) is configured to implement step S601 as above-described with reference to FIG. 6, the details of which are not repeated herein.

The output vector obtaining unit (702) is configured to obtain, based on the matrix of word vectors, output vectors to represent contextual semantic relationships. In some embodiments, the output vector obtaining unit (702) is configured to implement step S602 as above-described with reference to FIG. 6, the details of which are not repeated herein.

The convolution processing unit (703) is configured to obtain, based on the output vectors, a convolution result related to a topic. In some embodiments, the convolution processing unit (703) is configured to implement step S603 as above-described with reference to FIG. 6, the details of which are not repeated herein.

The semantic encoding unit (704) is configured to obtain, based on the convolution result, a fixed-length vector as a semantic encoding of the textual data to represent the topic of the textual data. In some embodiments, the semantic encoding unit (704) is configured to implement step S604 as above-described with reference to FIG. 6, the details of which are not repeated herein.

In some embodiments, one or more units or modules of the apparatus provided by the disclosure are configured to implement methods substantially similar to the above-described FIGS. 2, 3 and 6, the details of which are not repeated herein.

Other embodiments of the disclosure will be readily conceivable by those skilled in the art after considering the specification and practicing the invention disclosed herein. The disclosure is intended to cover any variations, uses, or adaptations of the disclosure, and the variations, uses, or adaptations are governed by the general principles of the disclosure and include commonly known knowledge or conventional technical means in the field that are not disclosed in the present disclosure. The specification and embodiments are considered illustrative only and the actual scope and spirit of the disclosure are indicated by the appended claims.

It should be understood that the disclosure is not limited to the exact structure described above and illustrated in the accompanying drawings, and various modifications and variations can be made without departing from the scope of the disclosure. The scope of the disclosure is limited only by the appended claims.

It needs to be noted that the relational terms such as “first” and “second” herein are merely used to distinguish one entity or operation from another entity or operation, and do not require or imply that the entities or operations have this actual relation or order. Moreover, the terms “include,” comprise” or other variations thereof are intended to cover non-exclusive inclusion, so that a process, a method, an article, or a device including a series of elements not only includes the elements, but also includes other elements not clearly listed, or further includes inherent elements of the process, method, article, or device. The element defined by the statement “including one,” without further limitation, does not preclude the presence of additional identical elements in the process, method, commodity, or device that includes the element. The disclosure may be described in a general context of computer-executable instructions executed by a computer, such as a program module. Generally, the program module includes routines, programs, objects, components, data structures, and so on, for executing particular tasks or implementing particular abstract data types. The disclosure may also be implemented in distributed computing environments. In the distributed computing environments, tasks are executed by remote processing devices that are connected by a communication network. In a distributed computing environment, the program module may be located in local and remote computer storage media including storage devices.

The embodiments in the present specification are described in a progressive manner, and for identical or similar parts between different embodiments, reference may be made to each other so that each of the embodiments focuses on differences from other embodiments. Especially, with regard to the apparatus embodiments, because the apparatus embodiments are substantially similar to the method embodiments, the description is relatively concise, and reference can be made to the description of the method embodiments for related parts. The device embodiments described above are merely illustrative, where the units described as separate components may or may not be physically separate, and the components displayed as units may or may not be physical units, that is, may be located at the same place, or may be distributed to a plurality of network units. The objective of the solution of this embodiment may be implemented by selecting a part of or all the modules according to actual requirements. Those of ordinary skill in the art could understand and implement the present invention without creative efforts. The above descriptions are merely implementations of the disclosure. It should be pointed out that those of ordinary skill in the art can make improvements and modifications without departing from the principle of the disclosure, and the improvements and modifications should also be construed as falling within the protection scope of the disclosure.

1-11. (canceled)

12. A method comprising:
generating, based on textual data, a matrix of word vectors, each word vector of the matrix corresponding to a word of the textual data;
obtaining, based on the matrix of word vectors, output vectors representing contextual semantic relationships;
obtaining, based on the output vectors, a convolution result related to a topic; and
obtaining, based on the convolution result, a fixed-length vector representing a semantic encoding of the textual data, the semantic encoding representing the topic of the textual data.

13. The method of claim 12, the obtaining the output vectors representing the contextual semantic relationships comprising inputting the matrix of word vectors into a bidirectional recurrent neural network to pre-process the matrix of word vectors into the output vectors.

14. The method of claim 13, the inputting the matrix of word vectors into the bidirectional recurrent neural network to pre-process the matrix of word vectors into the output vectors comprising:
performing forward processing to obtain a first semantic dependency relationship between each word vector of the matrix and a preceding contextual text;
performing backward processing to obtain a second semantic dependency relationship between each word vector of the matrix and a following contextual text; and
generating the output vectors based on the first semantic dependency relationship and second semantic dependency relationship.

15. The method of claim 13, the inputting the matrix of word vectors into the bidirectional recurrent neural network to pre-process the matrix of word vectors into the output vectors comprising performing computations using a long short-term memory (LSTM) unit of the bidirectional recurrent neural network.

16. The method of claim 12, the obtaining the fixed-length vector as the semantic encoding of the textual data comprising performing pooling on the convolution result to obtain the fixed-length vector as the semantic encoding of the textual data.

17. The method of claim 16, the performing pooling on the convolution result to obtain the fixed-length vector as the semantic encoding of the textual data comprising performing max-pooling on the convolution result to eliminate varying lengths associated with the convolution result and obtaining a fixed-length vector of real numbers as the semantic encoding of the textual data, a value of an element of the vector representing an extent to which the textual data reflects the topic.

18. The method of claim 12, the obtaining the convolution result related to the topic comprising:
performing linear convolution on the output vectors using a convolution kernel, the convolution kernel being related to the topic; and
performing nonlinear transformation on a result of the linear convolution to obtain the convolution result.

19. The method of claim 12, the textual data having varying-lengths.

20. A non-transitory computer-readable storage medium for tangibly storing computer program instructions capable of being executed by a computer processor, the computer program instructions defining the steps of:
generating, based on textual data, a matrix of word vectors, each word vector of the matrix corresponding to a word of the textual data;
obtaining, based on the matrix of word vectors, output vectors representing contextual semantic relationships;
obtaining, based on the output vectors, a convolution result related to a topic; and
obtaining, based on the convolution result, a fixed-length vector representing a semantic encoding of the textual data, the semantic encoding representing the topic of the textual data.

21. The computer-readable storage medium of claim 20, the obtaining the output vectors representing the contextual semantic relationships comprising inputting the matrix of word vectors into a bidirectional recurrent neural network to pre-process the matrix of word vectors into the output vectors.

22. The computer-readable storage medium of claim 21, the inputting the matrix of word vectors into the bidirectional recurrent neural network to pre-process the matrix of word vectors into the output vectors comprising:
performing forward processing to obtain a first semantic dependency relationship between each word vector of the matrix and a preceding contextual text;
performing backward processing to obtain a second semantic dependency relationship between each word vector of the matrix and a following contextual text; and
generating the output vectors based on the first semantic dependency relationship and second semantic dependency relationship.

23. The computer-readable storage medium of claim 20, the obtaining the fixed-length vector as the semantic encoding of the textual data comprising performing pooling on the convolution result to obtain the fixed-length vector as the semantic encoding of the textual data.

24. The computer-readable storage medium of claim 23, the performing pooling on the convolution result to obtain the fixed-length vector as the semantic encoding of the textual data comprising performing max-pooling on the convolution result to eliminate varying lengths associated with the convolution result and obtaining a fixed-length vector of real numbers as the semantic encoding of the textual data, a value of an element of the vector representing an extent to which the textual data reflects the topic.

25. The computer-readable storage medium of claim 20, the obtaining the convolution result related to the topic comprising:
performing linear convolution on the output vectors using a convolution kernel, the convolution kernel being related to the topic; and
performing nonlinear transformation on a result of the linear convolution to obtain the convolution result.

26. An apparatus comprising:
a processor; and
a storage medium for tangibly storing thereon program logic for execution by the processor, the stored program logic comprising:
logic, executed by the processor, for generating, based on textual data, a matrix of word vectors, each word vector of the matrix corresponding to a word of the textual data;
logic, executed by the processor, for obtaining, based on the matrix of word vectors, output vectors representing contextual semantic relationships;
logic, executed by the processor, for obtaining, based on the output vectors, a convolution result related to a topic; and
logic, executed by the processor, for obtaining, based on the convolution result, a fixed-length vector representing a semantic encoding of the textual data, the semantic encoding representing the topic of the textual data.

27. The apparatus of claim 26, the logic for obtaining the output vectors representing the contextual semantic relationships comprising logic, executed by the processor, for inputting the matrix of word vectors into a bidirectional recurrent neural network to pre-process the matrix of word vectors into the output vectors.

28. The apparatus of claim 27, the logic for inputting the matrix of word vectors into the bidirectional recurrent neural network to pre-process the matrix of word vectors into the output vectors comprising:
logic, executed by the processor, for performing forward processing to obtain a first semantic dependency relationship between each word vector of the matrix and a preceding contextual text;
logic, executed by the processor, for performing backward processing to obtain a second semantic dependency relationship between each word vector of the matrix and a following contextual text; and
logic, executed by the processor, for generating the output vectors based on the first semantic dependency relationship and second semantic dependency relationship.

29. The apparatus of claim 26, the logic for obtaining the fixed-length vector as the semantic encoding of the textual data comprising logic, executed by the processor, for performing pooling on the convolution result to obtain the fixed-length vector as the semantic encoding of the textual data.

30. The apparatus of claim 29, the logic for performing pooling on the convolution result to obtain the fixed-length vector as the semantic encoding of the textual data comprising logic, executed by the processor, for performing max-pooling on the convolution result to eliminate varying lengths associated with the convolution result and obtaining a fixed-length vector of real numbers as the semantic encoding of the textual data, a value of an element of the vector representing an extent to which the textual data reflects the topic.

31. The apparatus of claim 26, the logic for obtaining the convolution result related to the topic comprising:
logic, executed by the processor, for performing linear convolution on the output vectors using a convolution kernel, the convolution kernel being related to the topic; and
logic, executed by the processor, for performing nonlinear transformation on a result of the linear convolution to obtain the convolution result.
